(19) United States
(12) Patent Application Publication
(10) Pub. No.: US 2012/0287208 A1
(43) Pub. Date: Nov. 15, 2012

(54) LIQUID EJECTING APPARATUS

(75) Inventors: Masaru KOBASHI, Matsumoto (JP); Yoichi YAMADA, Shiojiri (JP); Toshiya OKADA, Chino (JP)

(73) Assignee: SEIKO EPSON CORPORATION, Tokyo (JP)

(21) Appl. No.: 13/468,397

(22) Filed: May 10, 2012

(30) Foreign Application Priority Data
May 12, 2011 (JP) 2011-106979

(51) Int. Cl. B41J 2/045

(52) U.S. Cl. 347/68

(57) ABSTRACT

A liquid ejecting apparatus includes: a pressure generation unit that is driven by application of a driving signal and causes a change in pressure on a liquid inside a pressure chamber; a liquid ejecting head that ejects the liquid toward a landing target from a nozzle when the pressure generation unit is driven; a charging member that performs charging by friction with another material; a liquid droplet collection member that collects at least a part of a liquid droplet which has not been landed on the landing target; and an electrode member that faces at least a part of the charging member with a gap formed between the electrode member and the charging member. The liquid droplet collection member is electrically connected to the electrode member and a charge with the same polarity as a charged polarity of the charging member is induced to the liquid droplet collection member.

### CROSS REFERENCES TO RELATED APPLICATIONS

The present invention contains subject matter related to Japanese Patent Application No. 2011-106979 filed in the Japanese Patent Office on May 12, 2011, the entire contents of which are incorporated herein by reference.

### BACKGROUND

1. Technical Field

The present invention relates to a liquid ejecting apparatus such as an ink jet recording apparatus, and more particularly, to a liquid ejecting apparatus capable of ejecting a liquid from the nozzles of a pressure chamber by driving of a pressure generation unit.

2. Related Art

A liquid ejecting apparatus is an apparatus that includes a liquid ejecting head and ejects various kinds of liquids from the ejecting head. Examples of the liquid ejecting apparatus include image recording apparatuses such as ink jet printers or ink jet plotters an ink jet printer and an ink jet plotter. In recent years, the liquid ejecting apparatus has been also applied to various manufacturing apparatuses, since the liquid ejecting apparatus has characteristics in which a very small amount of liquid can be accurately landed on a predetermined position. For example, the liquid ejecting apparatus has been applied to, for example, a display manufacturing apparatus that manufactures a color filter of a liquid crystal display or the like, an electrode forming apparatus that forms an electrode of an organic EL (Electro Luminescence) display, an FED (Field Emission Display), or the like, and a chip manufacturing apparatus that manufactures a bio chip (biochemical element). A recording head of an image recording apparatus ejects liquid ink and a color material ejecting head of a display manufacturing apparatus ejects the solution of each color material of R (Red), G (Green), and B (Blue). An electrode material ejecting head of an electrode forming apparatus ejects a liquid electrode material and a bioorganic matter ejecting head of a chip manufacturing apparatus ejects a bioorganic solution.

In recent years, to meet a demand for, for example, improvement of an image, the amount of ink to be ejected from the nozzles of a recording head used in the printer or the like described above has a tendency to decrease. To reliably land a minute amount of a liquid droplet on a recording medium, the initial speed of the liquid droplet is set to be relatively high. Accordingly, while the liquid droplet is flying, the liquid droplet ejected from a nozzle is elongated long and is separated into a head main liquid droplet (main liquid droplet) and a satellite liquid droplet (sub-liquid droplet) after the main liquid droplet. Since a part or the entirety of the satellite liquid droplet sharply decreases in speed due to the viscosity resistance of air, the liquid droplet may not arrive at the recording medium and may turn into a mist. For this reason, a problem may arise in that an operation failure may occur since the satellite liquid droplet (mist) turning into the mist contaminates the inside of an apparatus and attaches to easily charged members, such as a recording head or an electric circuit.

In order to prevent such a problem, a method of reliably landing a mist on an absorption member has been suggested, which is provided in a support member (or a platen) that supports a recording medium in a recording process and absorbs liquid droplets, by charging liquid droplets ejected from a nozzle and forming an electric field between the absorption member and a nozzle formation surface of the recording head (for example, see JP-A-2010-173324).

As schematically shown in FIG. 9A, while ink ejected from a nozzle 80 of a recording head grows toward a recording medium P and a support member 81, electrostatic induction from the positively charged support member 81 causes negative charge to be induced in a head portion (a portion of a main liquid droplet Md) close to the support member 81 and causes positive charge to be induced in a rear-end portion close to the nozzle 80 which is opposite to the head portion. As shown in FIG. 9B, for example, when the ink ejected from the nozzle is separated into the main liquid droplet Md, a first satellite liquid droplet Sd1, and a second satellite liquid droplet (mist) Sd2, the main liquid droplet Md is negatively charged, the second satellite liquid droplet Sd2 is positively charged, and the first satellite liquid droplet Sd1 is not charged. In this case, even when the main liquid droplet Md and the first satellite liquid droplet Sd1 are landed on the recording medium P, the second satellite liquid droplet Sd2 reacts against the positively charged support member 81, and thus turns into a mist and drifts near a nozzle formation surface of the recording medium. A part of the mist is attached to the nozzle formation surface. When the mist is attached to the nozzle formation surface, it is necessary to remove the mist attached to the nozzle formation surface periodically by a wiping member. Further, there is a concern that the mist which is not attached to the nozzle formation surface may be attached to and contaminate constituent elements different in polarity from the mist in the printer.

Accordingly, a configuration has been suggested in which ink is ejected from a nozzle when the support member (base substrate) is negatively charged, the polarity of the support member is switched to a positive polarity at a separation timing of the liquid droplet into the main liquid droplet and the satellite liquid droplet so that the main liquid droplet is landed on the recording medium through force of inertia, and the satellite liquid droplet or the mist is drawn to the support member charged to the reverse polarity to the polarity of the satellite liquid droplet or the mist to land the satellite liquid droplet or the mist on the recording medium (for example, see JP-A-2010-214880).

In recent years, however, a driving frequency for ink ejection has a tendency to be higher in such a printer. Therefore, the subsequent ink is ejected from a nozzle before the satellite liquid droplet is landed on the recording medium in some cases. Therefore, in a configuration in which the polarity of an electrode is switched at the ejection timing of the ink or the separation timing of the ink, there is a concern that it may be difficult to reliably land the satellite liquid droplet on the recording medium and the satellite liquid droplet may be unstably landed due to the influence of the flying of the main liquid droplet.

A configuration in which no electric field is formed between the nozzle formation surface and the support member to prevent the charging of the ink can be considered. In this configuration, however, the ejected ink is known to be charged even when the ink is ejected from the nozzle. That is, for example, FIG. 10 shows a configuration in which a change in pressure on the ink inside a pressure chamber 86 is caused by applying a driving voltage to a driving electrode 85 of a piezoelectric vibrator 84 of a recording head and the ink is ejected to the recording medium P from a nozzle 87 using the change in the pressure. In this configuration, when a positive voltage is input into a driving electrode 85 of the piezoelectric vibrator 84, the electrostatic induction causes negative charge to be induced the ink of the pressure chamber 86 near the piezoelectric vibrator 84 in that the piezoelectric vibrator 84 and the pressure chamber 86 are insulated from each other. The positive charge are induced in the ink near the nozzle 87 opposite to the piezoelectric vibrator 84. Since a nozzle formation surface 88 is grounded in a general recording head, the positive charge move in the ink on the side of the nozzle formation surface 88. However, when the ink is ejected at a higher driving frequency, as described above, the ink is ejected from the nozzle 87 in the state where the positive charge remain. As a result, the ink ejected from the nozzle 87 is positively charged.

When the ink ejected from the nozzle 87 is flying toward the recording medium P, the ink has a tendency in which the positive charge is strong by the Lenard effect (the negative charge is weak when the negatively charged ink is ejected). That is, when the ink is charged, the positive charge gather at the central portion of the liquid droplet and the negative charge gather at the superficial portion of the liquid droplet. As the superficial portion evaporates or splits during the flying of the liquid droplet, the liquid droplet gradually becomes positive.

Accordingly, in the configuration in which no electric field is formed between the nozzle formation surface and the support member, the ink ejected from the nozzle is charged. Therefore, a problem may arise in that the mist is attached to the nozzle formation surface or constituent elements of a printer.

The above-mentioned phenomenon occurs in not only the piezoelectric vibrator but also other pressure generation units, such as a heating element, operated by application of a driving voltage.

### SUMMARY

An advantage of some aspects of the invention is that it provides a liquid ejecting apparatus capable of preventing a liquid ejected from a nozzle from being attached to another member in an apparatus when the liquid is landed on a predetermined member.

According to an aspect of the invention, there is provided a liquid ejecting apparatus including: a pressure generation unit that is driven by application of a driving signal and causes a change in pressure on a liquid inside a pressure chamber; a liquid ejecting head that ejects the liquid toward a landing target from a nozzle when the pressure generation unit is driven; a charging member that performs charging by friction with another material; a liquid droplet collection member that collects at least a part of a liquid droplet which has not been landed on the landing target; and an electrode member that faces at least a part of the charging member with a gap formed between the electrode member and the charging member. The liquid droplet collection member is electrically connected to the electrode member and a charge with the same polarity as a charged polarity of the charging member is induced to the liquid droplet collection member.

According to the aspect of the invention, the mist can be collected by the liquid droplet collection member by inducing charge to the liquid droplet collection member to be charged. Thus, the attachment of the mist to other constituent elements (for example, a motor, a driving belt, a linear scale, and the like) in the liquid ejecting apparatus can be reduced. As a result, since the breakdown caused due to the attachment of the mist is suppressed, the durability and reliability of the liquid ejecting apparatus are improved. Further, since it is not necessary to separately provide a voltage generation unit such as a power source, the manufacturing cost of the liquid ejecting apparatus can be reduced and the power consumption of the liquid ejecting apparatus can be reduced.

In the liquid ejecting apparatus, the liquid droplet collection member may be charged with a reverse polarity to a polarity of the driving signal.

With such a configuration, when the pressure generation unit is driven, the electrostatic induction generated by the voltage applied to the pressure generation unit causes the liquid near the nozzles to be charged. Thus, when the liquid ejected from the nozzles and the mist are charged with the same polarity as the driving signal, the liquid droplet collection member can collect the mist.

In the liquid ejecting apparatus, the liquid droplet collection member may be charged with a negative polarity.

With such a configuration, when the mist is charged with the positive polarity, the liquid droplet collection member can collect the mist according to the Lenard effect.

In the liquid ejecting apparatus, the charging member may be formed of a dielectric substance.

With such a configuration, the charge can be prevented from being released from the charging member after the liquid ejecting apparatus is driven. Therefore, the charging of the liquid droplet collection member by the induction of the charge can be held for a long time. Thus, even after the liquid ejecting apparatus is driven, the mist can be collected.

In the liquid ejecting apparatus, in a surface of the electrode member facing the charging member, an area of a region overlapping the charging member may be greater than a contact area of the liquid droplet collection member with air.

With such a configuration, since the amount of charge induced to the liquid droplet collection member is greater than the amount of charge of the liquid droplet collection member removed (electrically discharged) by the air, the liquid droplet collection member can be charged more reliably. Further, after the liquid ejecting apparatus is driven, the charging of the liquid droplet collection member can be held for a longer time.

The liquid ejecting apparatus may further include a roller that transports the landing target; and a transfer belt that transfers a power from a power source to the roller. The transfer belt may serve as the charging member.

With such a configuration, since the liquid droplet collection member can be charged in the transport of the landing target, the mist can be collected when the mist flies due to an air current generated with the transport of the landing target. As a result, the mist can be prevented from flying, and thus the mist can be collected reliably.

The liquid ejecting apparatus may further include a movement mechanism that moves the liquid ejecting head. The movement mechanism may include a driving pulley installed in a driving shaft of a driving source, a free rotation pulley rotating integrally with the driving pulley, and a driving belt suspended between the driving pulley and the free rotation pulley. The driving belt may be charged by the charging member.

With such a configuration, since the liquid droplet collection member can be charged in the movement of the liquid ejecting head, the mist can be collected when the mist flies due to an air current generated with the movement of the liquid ejecting head. As a result, the mist can be prevented from flying, and thus the mist can be collected more reliably.

### BRIEF DESCRIPTION OF THE DRAWINGS

The invention will be described with reference to the accompanying drawings, wherein like numbers reference like elements.

FIG. 1A is a plan view illustrating the configuration of a printer and FIG. 1B is a sectional view taken along the line IB-IB.

FIG. 2 is a sectional view illustrating main portions of a recording head.

FIG. 3 is a sectional view illustrating the configuration of a piezoelectric vibrator.

FIG. 4 is a block diagram illustrating the electric configuration of the recording head.

FIG. 5 is a diagram illustrating the waveforms of an ejection driving pulse and a minute vibration driving pulse.

FIG. 6 is a schematic diagram illustrating charging of a liquid collection unit.

FIG. 7 is a sectional view illustrating main units of a printer according to a second embodiment.

FIG. 8 is a front view illustrating main unit of a printer according to a third embodiment.

FIGS. 9A and 9B are schematic diagrams illustrating a case in which ink ejected from a nozzle is charged when an electric field is formed between the nozzle and a support member.

FIG. 10 is a schematic diagram illustrating a case in which ink ejected from a nozzle is charged when no electric field is formed between the nozzle and a support member.

### DESCRIPTION OF EXEMPLARY EMBODIMENTS

Hereinafter, embodiments of the invention will be described with reference to the accompanying drawings. The embodiments described below are limited as preferred examples of the invention in various forms, but the scope of the invention is not limited to the embodiments unless the limitation is otherwise specifically described. Hereinafter, an ink jet recording apparatus 1 (hereinafter, referred to as a printer) will be described as the liquid ejecting apparatus according to the invention.

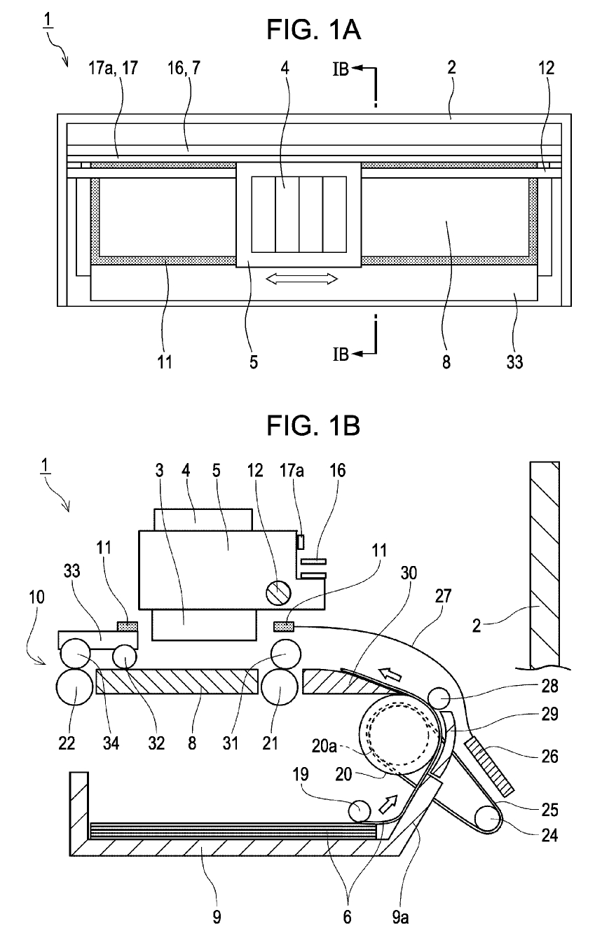

FIG. 1A is a plan view illustrating the configuration of the printer 1. FIG. 1B is a sectional view taken along the line IB-IB. In the printer 1, a recording head 3 which is a kind of liquid ejecting head is mounted inside a casing 2. The printer 1 includes a carriage 5 on which ink cartridges 4 which are kinds of liquid supply sources are detachably mounted, a carriage movement mechanism 7 (corresponding to a movement mechanism according to the invention) that reciprocates the carriage 5 in a sheet surface direction of a recording sheet 6 (which is a kind of recording medium and a landing target), that is, a main scanning direction, and a platen 8 that is provided with a gap formed between the platen 8 and the lower surface (nozzle formation surface) of the recording head 3 below the printing head 3 when a recording process (ejecting process) is performed. A sheet feeding tray 9 that accommodates the plurality of recording sheets 6 in a piling manner is provided below the platen 8. The printer 1 further includes a transport mechanism 10 that transports the recording sheet 6 accommodated in the sheet feeding tray 9 along a transport path formed in a sub-scanning direction perpendicular to the main scanning direction and a liquid droplet collection member 11 that is provided at a position at which the liquid droplet collection member 11 does not interfere with the recording head 3.

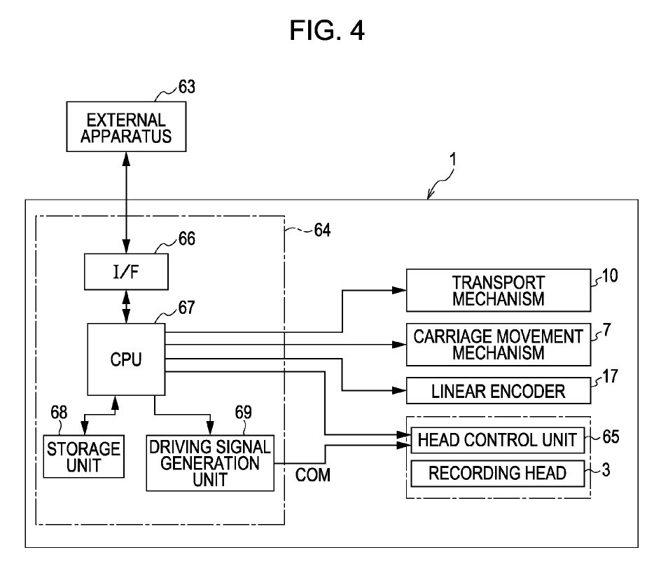

The carriage 5 is mounted to be shaft-supported to a guide rod 12 installed in the main scanning direction and is configured to be moved in the main scanning direction along the guide rod 12 by an operation of the carriage movement mechanism 7. The carriage movement mechanism 7 according to this embodiment includes a driving pulley 14 that is installed in a driving shaft of a carriage motor (which is a kind of driving source) (not shown), a free rotation pulley 15 that rotates integrally with the driving pulley 14, and a driving belt 16 that is suspended between the free rotation pulley 15 and the driving pulley 14. The driving pulley 14 is located one end in the main scanning direction and rotates in response to the driving of the carriage motor. The free rotation pulley 15 that is freely rotatable is installed at a position opposite to the driving pulley 14 in the main scanning direction. The driving belt 16 which is an endless belt is suspended between these pulleys and a part of the driving belt 16 is connected to the carriage 5. Therefore, when the carriage motor is driven, the driving belt 16 is moved, and thus the carriage 5 (the recording head 3) is moved in the main scanning direction. The position of the carriage 5 in the main scanning direction is detected by a linear encoder 17. The linear encoder 17 includes a linear scale 17a suspended in the main scanning direction and a sensor (not shown) provided in the carriage 5. Therefore, a detection signal, that is, an encoder pulse EP (which is a kind of positional information) corresponding to a scanning position of the recording head 3 is transmitted to a printer controller 64 (see FIG. 4).

The platen 8 is a plate-shaped member that is long in the main scanning direction and is grounded (earthed) in this embodiment. The recording head 3 performs a recording process on the recording sheet 6 transported on the platen 8. The sheet feeding tray 9 which is a tray with a space accommodating the recording sheet 6 is configured to be detachably mounted on the casing 2. An edge guide (not shown) is installed in the bottom portion of the sheet feeding tray 9. Therefore, the side end position and the rear end position of the recording sheet 6 accommodated in the sheet feeding tray 9 are regulated by the edge guide. Further, a sheet feeding guide portion 9a inclined upward toward a reversing guide member 29 is formed on the rear side (on the side of the reversing guide member 29 described below) of the sheet feeding tray 9.

The transport mechanism 10 includes a sheet feeding roller 19, a reversing roller 20, a transport driving roller 21, and a sheet discharging roller 22. The sheet feeding roller 19 is shaft-supported by the rotation shaft of a driving motor (not shown). The sheet feeding roller 19 sends the uppermost recording sheet 6 toward the sheet feeding guide portion 9a of the sheet feeding tray 9 when the sheet feeding roller 19 comes into contact with the uppermost recording sheet 6 in the sheet feeding tray 9 and rotates. The reversing roller 20 is disposed above the sheet feeding guide portion 9a. The reversing roller 20 is shaft-supported to be rotatable and includes a transfer gear portion 20a in one end in the rotation shaft direction and the outside of the transport path of the recording sheet 6. A transfer belt 25 (which is a kind of stepped belt) that transfers the power from a driving gear 24 installed on the rear side (to the rear side of the sheet feeding guide portion 9a) of the printer 1 is suspended in the transfer gear portion 20a. The driving gear 24 is shaft-supported in a driving motor (corresponding to a power source according to the invention) (not shown) and is rotated by the driving of the driving motor. In this embodiment, the transfer belt 25 is configured to be charged negatively (with negative polarity) by friction between the transfer belt 25, and the transfer gear portion 20a and the driving gear 24, specifically, by friction when the teeth of the gear are meshed with or come off the end portion of the transfer belt 25. Specifically, the transfer belt 25 is formed of a dielectric substance (insulating substance) and a member (for example, polyurethane or silicon rubber) easily charged negatively in triboelectric series. The transfer gear portion 20a or the driving gear 24 are formed of a member (for example, acrylic resin or hard rubber) easily charged positively more than the transfer belt 25 in triboelectric series. In this embodiment, the transfer belt 25 corresponds to a charging member according to the invention. Further, the transfer gear portion 20a and the driving gear 24 may be configured as a sprocket so that the transfer belt 25 serves as a chain belt mutually engaged with the sprocket.

An electrode plate 26 (corresponding to an electrode member according to the invention) that faces at least a part of the transfer belt 25 with a gap formed therebetween is provided on the side of the upper surface of the transfer belt 25. The electrode plate 26 is formed of, for example, a metal plate with high conductivity. One end of the electrode plate 26 is electrically connected to one end of a conductive wire 27 connected to the liquid droplet collection member 11. In this embodiment, the transfer belt 25 and the electrode plate 26 are formed to have a large width. Therefore, in a surface of the electrode plate 26 facing the transfer belt 25, the area of a region overlapping the transfer belt 25 is configured to be greater than the contact area of the liquid droplet collection member 11 with the air. The charging of the electrode plate 26 and the liquid droplet collection member 11 will be described later.

An auxiliary roller 28 coming into contact with the reversing roller 20 is disposed on the upward inclined side of the reversing roller 20. The reversing guide member 29 formed in an arc shape along the curved surface of the reversing roller 20 is disposed between the auxiliary roller 28 and the upper end portion of the sheet feeding guide portion 9a. The auxiliary roller 28 is shaft-supported to be freely rotated and is mounted to come into contact (or to be slightly spaced) with the reversing roller 20. The reversing guide member 29 is disposed so that a slight space through which the recording sheet 6 passes is present between the reversing guide member 29 and the reversing roller 20. Thus, the reversing guide member 29 guides the recording sheet 6 from the sheet feeding guide portion 9a of the sheet feeding tray 9 to the auxiliary roller 28. Then, the recording sheet 6 transported up to the auxiliary roller 28 is curved and reversed by the rotation of the reversing roller 20 in a state where the recording sheet 6 is pinched between the auxiliary roller 28 and the reversing roller 20, and then is sent toward the guide member 30 (the transport path of the upper side (sheet feeding downstream side)).

A transport driving roller 21 and a transport driven roller 31 transporting the recording sheet 6 sent onto the guide member 30 to the platen 8 are provided between the guide member 30 and the platen 8. The transport driving roller 21 is shaft-supported in a rotation shaft of a driving motor (not shown). The transport driven roller 31 is shaft-supported to be freely rotated and is disposed to come into contact (or to be slightly spaced) with the transport driving roller 21. Thus, the recording sheet 6 is pinched between the transport driving roller 21 and the transport driven roller 31, and then the recording sheet 6 is transported toward the platen 8 when the transport driving roller 21 is rotated by the driving of the driving motor.

Sheet pressing rollers 32 that pinches the recording sheet 6 between the sheet pressing rollers 32 and the platen 8, and a sheet pressing member 33 on which the sheet pressing rollers 32 are mounted and which urges the sheet pressing rollers 32 to the side of the platen 8 are provided on the front end portion (the downstream side of the transport direction of the recording sheet 6) of the platen 8. The sheet pressing member 33 is a long plate-shaped member. The sheet pressing member 33 is mounted to be urged to the side (the side of the platen 8) of the recording sheet 6 by an urging member such as a spring or its weight with a space formed with the recording head 3 so that the sheet pressing member 33 does not interfere with the recording head 3. On the side of the platen 8 in the sheet pressing member 33, the sheet pressing rollers 32 can be arranged at the same interval in the main scanning direction. The sheet pressing rollers 32 are configured to freely rotate in a state where the sheet pressing rollers 32 come into contact with the surface of the recording sheet 6. Further, a part of the liquid droplet collection member 11 is disposed on the upper surface (the surface opposite to the platen 8) of the sheet pressing member 33.

A sheet discharge driving roller 22 and a sheet discharge driven roller 34 that discharge the recording sheet 6 subjected to a printing process are installed on the front side (the downstream side of the transport direction of the recording sheet 6) of the sheet pressing roller 32. The sheet discharge driving roller 22 is shaft-supported in a rotation shaft of a driving motor (not shown). The sheet discharge driven roller 34 is shaft-supported to freely rotate and is urged toward the sheet discharge driving roller 22 by an urging member such as a spring. Thus, the recording sheet 6 is pinched between the sheet discharge driving roller 22 and the sheet discharge driven roller 34, and then the recording sheet 6 is discharged when the sheet discharge driving roller 22 is rotated by the driving of the driving motor.

The recording sheet 6 fed from the inside of the sheet feeding tray 9 passes through the sheet feeding guide portion 9a, the reversing guide member 29, the reversing roller 20, the guide member 30, the transport driving roller 21, and the platen 8 and is transported along the transport path to the sheet discharge driving roller 22 by the driving of the transport mechanism 10 that includes the sheet feeding roller 19, the reversing roller 20, the transport driving roller 21, and the sheet discharge driving roller 22.

The liquid droplet collection member 11 is disposed at a position deviated from the nozzle formation surface on the opposite side to the recording sheet 6. In this embodiment, as shown in FIG. 1A, the liquid droplet collection member 11 is formed in a rectangular frame shape so as to surround the outer periphery of the movement range of the recording head 3 so that the liquid droplet collection member 11 does not interfere with the recording head 3. Specifically, one side of the liquid droplet collection member 11 is formed across the long side of the sheet pressing member 33 in the rear end portion (on the side of the recording head 3) of the upper surface of the sheet pressing member 33. The other side (the upstream side) opposite to the one side with the recording head 3 interposed therebetween is formed to be supported by a support member (not shown) on the upper side of the transport driven roller 31. Both end portions of these sides are connected to each other by a side parallel in the sub-scanning direction. The other end of the conductive wire 27 of which the one end is connected to the electrode plate 26 is electrically connected to a part of the liquid droplet collection member 11.

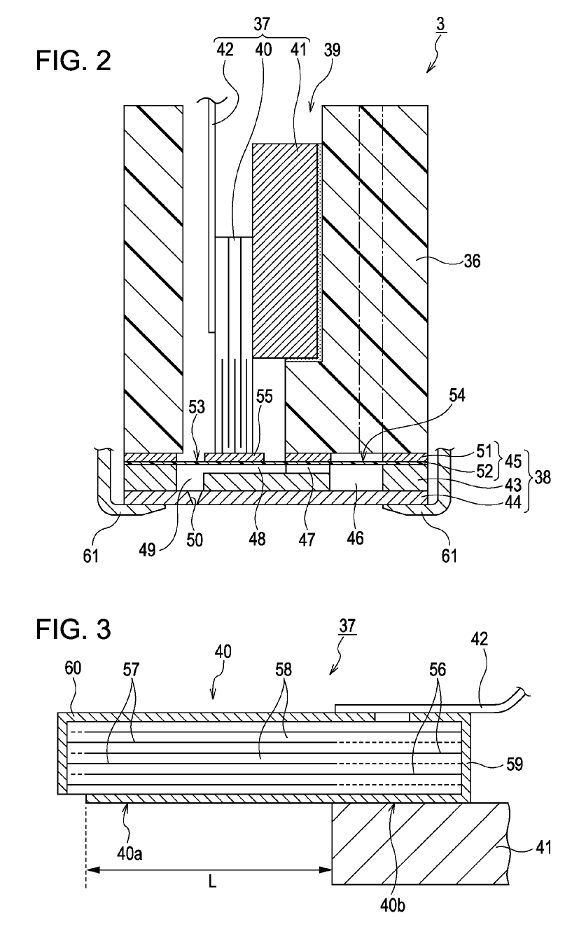

As shown in FIG. 2, the recording head 3 includes a case 36, a vibrator unit 37 accommodated inside the case 36, a flow passage unit 38 joined to the bottom surface (front end surface) of the case 36, and a cover member 61. The case 36 is manufactured by, for example, epoxy-based resin. An accommodation space portion 39 accommodating the vibrator unit 37 is formed inside the case 36. The vibrator unit 37 includes a piezoelectric vibrator 40 that functions as a kind of pressure generation unit, a fixing plate 41 to which the piezoelectric vibrator 40 is joined, and a flexible cable 42 that supplies a driving signal to the piezoelectric vibrator 40.

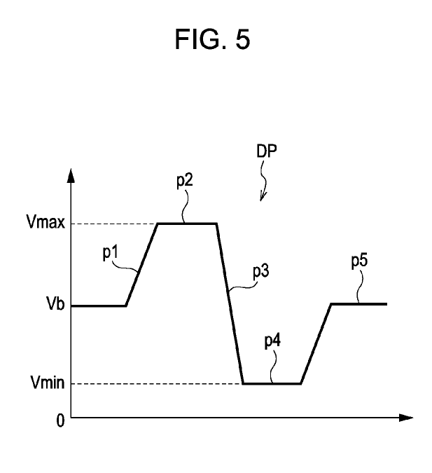

FIG. 3 is a sectional view illustrating the configuration of the vibrator unit 37 in an element length direction. As shown in FIG. 3, the piezoelectric vibrator 40 is a lamination type piezoelectric vibrator 40 in which each common internal electrode 56 and each individual internal electrode 57 are alternately laminated with a piezoelectric body 58 interposed therebetween. Here, the common internal electrode 56 is an electrode common to all of the piezoelectric vibrators 40 and is set to have a ground potential. The individual internal electrode 57 is an electrode of which a potential varies in accordance with an ejection driving pulse DP (see FIG. 5) of a driving signal to be applied. In this embodiment, a portion from the front end of the piezoelectric vibrator 40 to about half or about two thirds in a vibrator length direction (a direction perpendicular to a lamination direction) of the piezoelectric vibrator 40 is set as a free end portion 40a. The remaining portion of the piezoelectric vibrator 40, that is, a portion from the base end of the free end portion 40a to the base end of the vibrator is set as a base end portion 40b.

In the free end portion 40a, an active region (overlap portion) L in which the common internal electrode 56 and the individual internal electrode 57 overlap one another is formed. When a potential difference is given in the internal of the electrode, the piezoelectric body 58 in the active region L operates so as to be deformed, and thus the free end portion 40a is deformed in the vibrator length direction to be expanded and contracted. The base end of the common internal electrode 56 is electrically connected to the common external electrode 59 in the base end surface portion of the piezoelectric vibrator 40. In the front end surface portion of the piezoelectric vibrator 40, the front end of the individual internal electrode 57 is electrically connected to the individual external electrode 60. Further, since the front end of the common internal electrode 56 is located at a slightly more forward position (on a base end surface side) than the front end surface portion of the piezoelectric vibrator 40, the base ends of the individual internal electrodes 57 are located in the boundary between the free end portion 40a and the base end portion 40b.

The individual external electrode 60 is an electrode in which the front end surface portion of the piezoelectric vibrator 40 and a wiring connection surface (the upper surface in FIG. 3), which is one side surface of the piezoelectric vibrator 40 in the lamination direction, are formed in series manner. The individual external electrode 60 electrically connects a wiring pattern of the flexible cable 42 serving as a wiring member to each individual internal electrode 57. Further, portions of the individual external electrodes 60 on the side of the wiring connection surface are continuously formed from the base end portion 40b toward the front end side. The common external electrode 59 is an electrode in which a base end surface portion of the piezoelectric vibrator 40, the wiring connection surface, and a fixing plate mounting surface (the lower surface in FIG. 3), which is the other surface of the piezoelectric vibrator 40 in the lamination direction, are formed in a series manner. The common external electrode 59 is electrically connected between the wiring pattern of the flexible cable 42 and each common internal electrode 56. Further, portions of the common external electrodes 59 on the side of the wiring connection surface are continuously formed from the slight front position more than the end of the individual external electrode 60 toward the base end surface portion. Therefore, the portions of the piezoelectric vibrator 40 on the side of the fixing plate mounting surface are continuously formed from the slight front position than the front end surface portion of the piezoelectric vibrator 40 toward the base end.

The base end portion 40b is a non-operation portion that is not expanded and contracted even when the piezoelectric body 58 in the active region L operates. The flexible cable 42 is disposed on the side of the wiring connection surface of the base end portion 40b. Therefore, on the base end portion 40b, the individual external electrode 60 and the common external electrode 59 are electrically connected to the flexible cable 42. A driving signal is applied to each individual external electrode 60 via the flexible cable 42.

In the flow passage unit 38, a nozzle plate 44 is joined to one surface of a flow passage formation surface 43 and a vibration plate 45 is joined to the other end of the flow passage formation surface 43. The flow passage unit 38 includes a reservoir 46 (common liquid chamber), an ink supply port 47, a pressure chamber 48, and a nozzle communication port 49, and nozzles 50. A series of ink flow passage formed from the ink support port 47 to each nozzle 50 via the pressure chamber 48 and the nozzle communication port 49 corresponds to each nozzle 50.

The nozzle plate 44 is a thin plate made of a metal material such as stainless steel, in which the plurality of nozzles 50 are punched in a line shape at a pitch (for example, 180 dpi) corresponding to a dot formation density. A plurality of nozzle lines (nozzle groups) in which the nozzles 50 are lined are formed in the nozzle plate 44. One nozzle line is formed by, for example, 180 nozzles. A surface of the nozzle plate 44 in which ink is ejected from the nozzles 50 corresponds to a nozzle formation surface according to the invention.

The vibration plate 45 has a double structure in which an elastic film 52 is laminated on the surface of a support plate 51. In this embodiment, a stainless plate which is a kind of metal plate serves as the support plate 51. The vibration plate 45 is manufactured using a composite plate in which a resin film is laminated as the elastic film 52 on the surface of the support plate 51. The vibration plate 45 includes a diaphragm portion 53 that varies the volume of the pressure chamber 48. The vibration plate 45 includes a compliance portion 54 that seals a part of the reservoir 46.

The diaphragm portion 53 is manufactured by partially removing the support plate 51 by an etching process or the like. That is, the diaphragm portion 53 includes an island portion 55 to which the front end surface of the free end portion 40a of the piezoelectric vibrator 40 and a thin-walled elastic portion surrounding the island portion 55. The compliance portion 54 is manufactured by removing the support plate 51 in a region facing an opening surface of the reservoir 46 by an etching process or the like, as in the diaphragm portion 53. The compliance portion 54 functions as a damper that absorbs a change in the pressure of the liquid stored in the reservoir 46.

Since the front end surface of the piezoelectric vibrator 40 is joined to the island portion 55, the volume of the pressure chamber 48 can be changed by expanding and contracting the free end portion 40a of the piezoelectric vibrator 40. The change in the volume of the pressure chamber 48 causes the pressure of the ink in the pressure chamber 48 to be changed. Then, the recording head 3 ejects the ink from the nozzles 50 using the change in the pressure.

The cover member 61 is a member that protects the side surface of the flow passage unit 38 or the side surface of the case 36. The cover member 61 is manufactured from a plate having conductivity such as stainless steel. In this embodiment, a part of the cover member 61 comes into contact with a peripheral portion of the nozzle formation surface with the nozzles 50 of the nozzle plate 44 exposed, and thus is electrically connected to the nozzle plate 44. The cover member 61 is grounded. Therefore, by bringing the cover member 61 into contact with the nozzle plate 44 to be electrically connected, it is possible to prevent a damage to a driving IC or the like when static electricity generated from the recording sheet 6 or the like is transferred via the nozzle plate 44, or it is possible to prevent the nozzle plate 44 from being charged.

Next, the electric configuration of the printer 1 will be described. FIG. 4 is a block diagram illustrating the electric configuration of the printer 1. An external apparatus 63 is an electronic apparatus, such as a computer or a digital camera, that processes an image. The external apparatus 63 is connected to be communicable with a printer controller 64 of the printer 1. The external apparatus 63 transmits print data corresponding to an image or the like to the printer 1 so that the printer 1 can print the image or text on a recording medium such as the recording sheet 6.

The printer 1 according to this embodiment includes the transport mechanism 10, the carriage movement mechanism 7, the linear encoder 17, the recording head 3, and the printer controller 64.

The printer controller 64 is a control unit that controls each unit of the printer 1. The printer controller 64 includes an interface (I/F) unit 66, a CPU 67, a storage unit 68, and a driving signal generation unit 69. The interface unit 66 transmits and receives data to and from the printer 1. For example, the interface unit 66 receives print data or a print command transmitted from the external apparatus 63 to the printer 1 or transmits information on the state of the printer 1 to the external apparatus 63.

The CPU 67 is an arithmetic processing device that controls the entire printer 1. The storage unit 68 is an element that stores programs or data used in various kinds of control and includes a ROM, a RAM, a NVRAM (non-volatile storage element) of the CPU 67. The CPU 67 controls each unit in accordance with the program stored in the storage unit 68.

The CPU 67 functions as a timing pulse generation unit that generates a timing pulse PTS based on an encoder pulse EP output from the linear encoder 17. For example, the CPU 67 controls transmission of the print data in synchronization with the timing pulse PTS and generation of a driving signal COM by the driving signal generation unit 69. Further, the CPU 67 generates a timing signal such as a latch signal LAT based on the timing pulse PTS and outputs the timing signal to a head control unit 65 of the recording head 3. For example, the head control unit 65 controls the application of an ejection driving pulse DP (see FIG. 5) of the driving signal COM for the piezoelectric vibrator 40 of the recording head 3 based on head control signals (the print data and the timing signal) from the printer controller 64.

The driving signal generation unit 69 generates an analog voltage signal based on waveform data regarding the waveform of the driving signal. Further, the driving signal generation unit 69 amplifies the voltage signal and generates the driving signal COM. The driving signal COM is applied to the piezoelectric vibrator 40 which is the pressure generation unit of the recording head 3 in a printing process (a recording process or an ejection process) on the recording medium. The driving signal COM is a series of signals that at least includes the ejection driving pulse DP shown in FIG. 5 within a unit time which is a repetition period. Here, the ejection driving pulse DP is a pulse configured to allow the piezoelectric vibrator 40 to perform a predetermined process to eject ink with a liquid droplet shape from each nozzle 50 of the recording head 3.

FIG. 5 is a diagram illustrating an example of the configuration of the waveform of the ejection driving pulse DP included in the driving signal COM. In FIG. 5, the vertical axis represents a potential and the horizontal axis represents a time. As shown in FIG. 5, the ejection driving pulse DP according to this embodiment is positive on the average. The potential of the ejection driving pulse DP is changed from a reference potential (intermediate potential) Vb to the maximum potential (maximum voltage) Vmax in the positive direction. The ejection driving pulse DP includes an expansion component p1 expanding the pressure chamber 48, an expansion holding component p2 holding the maximum potential Vmax for a given time, a contraction component p3 sharply contracting the pressure chamber 48 as the potential is changed from the maximum potential Vmax to the minimum potential (minimum voltage) Vmin in the negative direction, a contraction holding (vibration suppression holding) component p4 holding the minimum potential Vmin for a given time, and a return component p5 returning the potential from the minimum potential Vmin to the reference potential Vb.

When the ejection driving pulse DP is applied to the piezoelectric vibrator 40, an operation is performed as follows. First, the piezoelectric vibrator 40 is contracted by the expansion component p1. As the piezoelectric vibrator 40 is contracted, the pressure chamber 48 is expanded from a reference volume corresponding to the reference potential Vb to the maximum volume corresponding to the maximum potential Vmax. Thus, a meniscus exposed to the inside of the nozzle 50 is drawn toward the pressure chamber 48. The expansion state of the pressure chamber 48 is held during the application period of the expansion holding component p2. When the contraction component p3 is applied to the piezoelectric vibrator 40 after the expansion holding component p2, the piezoelectric vibrator 40 is expanded. As the piezoelectric vibrator 40 is expanded, the pressure chamber 48 is sharply contracted from the maximum volume to the minimum volume corresponding to the minimum potential Vmin. When the pressure chamber 48 is sharply contracted, the ink inside the pressure chamber 48 is pressurized, and thus ink from several pl to tens of pl is ejected from the nozzle 50. The contraction state of the pressure chamber 48 is held for a short time during the application period of the contraction holding component p4. Thereafter, when the return component p5 is applied to the piezoelectric vibrator 40, the pressure chamber 48 is returned from the volume corresponding to the minimum potential Vmin to the reference volume corresponding to the reference potential Vb.

In this embodiment, the driving signal (the ejection driving pulse DP) has a positive polarity, as described above. Further, in the recording process, the ink near the piezoelectric vibrator 40 is induced to the negative charge and the ink near the nozzle 50 is induced to the positive charge inside the pressure chamber 48 by the electrostatic induction. Therefore, the ink ejected from the nozzle 50 is charged positively. Further, the ink flying toward the recording sheet 6 is strongly charged positively by the Lenard effect. Thus, a satellite liquid droplet formed in the separation of the ink during the flying of the ink or a mist (hereinafter, referred to as a mist or the like) minute more than the satellite liquid droplet is charged positively. A part of the mist or the like is not landed on the recording sheet 6 and floats.

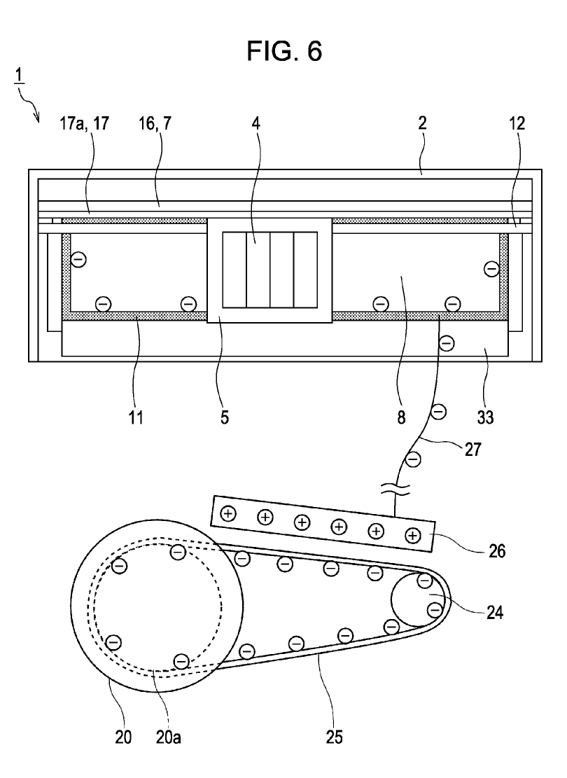

Next, the charging of the electrode plate 26 and the liquid droplet collection member 11 and the collection of the mist or the like will be described with reference to FIG. 6. When the transport mechanism 10 is driven to transport the recording sheet 6 in the recording process, the transfer belt 25 is gradually charged negatively by the friction between the transfer belt 25 and the transfer gear portion 20a of the reversing roller 20 or the driving gear 24. Thus, the positive charge is induced in the electrode plate 26 facing the transfer belt 25. On the other hand, the negative charge from the electrode plate 26 are transferred and induced to the liquid droplet collection member 11 via the conductive wire 27. As a result, the liquid droplet collection member 11 is charged negatively. Therefore, an electric field is formed between the liquid droplet collection member 11 and the constituent element of the printer 1 such as the case 2, the recording head 3, the motor, the driving belt 16, or the linear scale 17a. In particular, a relatively stronger electric field is formed between the liquid droplet collection member 11 and the portion of the recording head 3 facing the liquid droplet collection member 11, compared to the other constituent elements, except for a case in which the liquid droplet collection member 11 and the recording head 3 have the same potential. Further, the mist or the like charged positively is induced to the negatively charged liquid droplet collection member 11, and thus at least a part of the mist or the like is collected. The other constituent elements of the printer 1 can be considered to be charged negatively, but the liquid droplet collection member 11 is configured to be lower than the charging voltage.

Thus, since the charge of the liquid droplet collection member 11 is induced to and are charged to the opposite polarity (in this embodiment, the negative polarity) to that of the mist or the like formed with the ejection of the liquid from the nozzles 50, the mist or the like can be collected by the liquid droplet collection member 11. Accordingly, the attachment of the mist or the like to the other constituent elements (for example, the motor, the driving belt 16, or the linear scale 17a) of the printer 1 is reduced. As a result, a breakdown caused due to the attachment of the mist or the like is suppressed, and thus the durability and the reliability of the printer 1 are improved. Further, since it is not necessary to separately provide a voltage generation unit such as a power source, the manufacturing cost of the printer 1 can be reduced and the power consumption of the printer 1 can be reduced. Further, since the transfer belt 25 is formed of a dielectric substance, the charge can be prevented from being released from the charged transfer belt 25 after the driving of the printer 1 (after the driving of the reversing roller 20). Therefore, the charging of the liquid droplet collection member 11 by the induction of the charge can be held for a long time. Thus, the mist or the like can be collected, even after the printer 1 is driven. Further, in the face of the electrode plate 26 facing the transfer belt 25, the area of the region overlapping the transfer belt 25 is greater than the contact area of the liquid droplet collection member 11 with the air. Therefore, since the amount of charge induced to the liquid droplet collection member 11 is greater than the amount of charge of the liquid droplet collection member 11 removed by the air, the liquid droplet collection member 11 can be charged more reliably. Further, after the printer 1 is driven, the charging of the liquid droplet collection member 11 can be held for a longer time. The transfer belt 25 is charged when the reversing roller 20 transporting the recording sheet 6 is driven. Therefore, the mist or the like can be collected when the mist or the like flies due to an air current generated with the transport of the recording sheet 6. As a result, the mist or the like can be prevented from flying, and thus the mist or the like can be collected reliably.

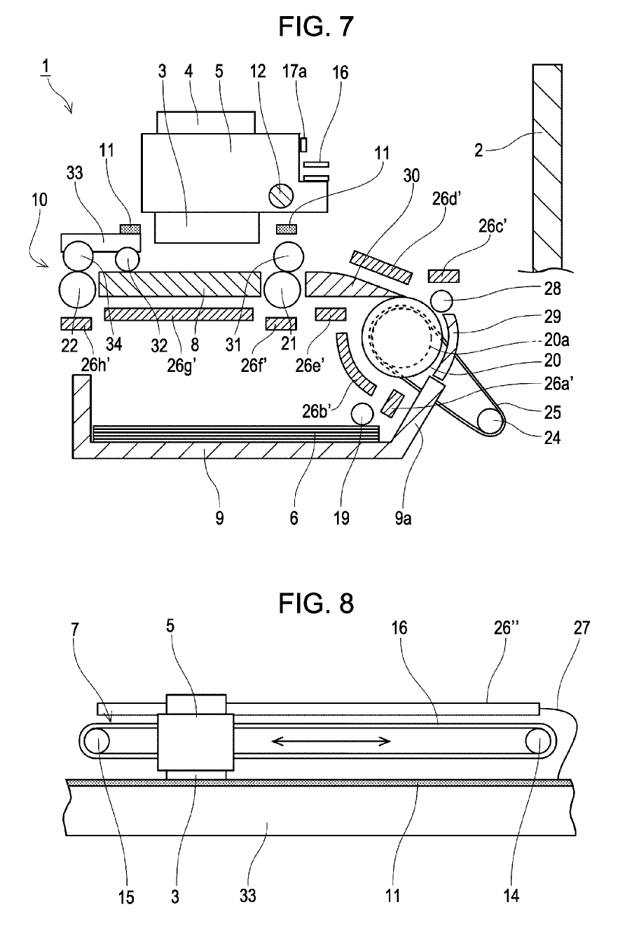

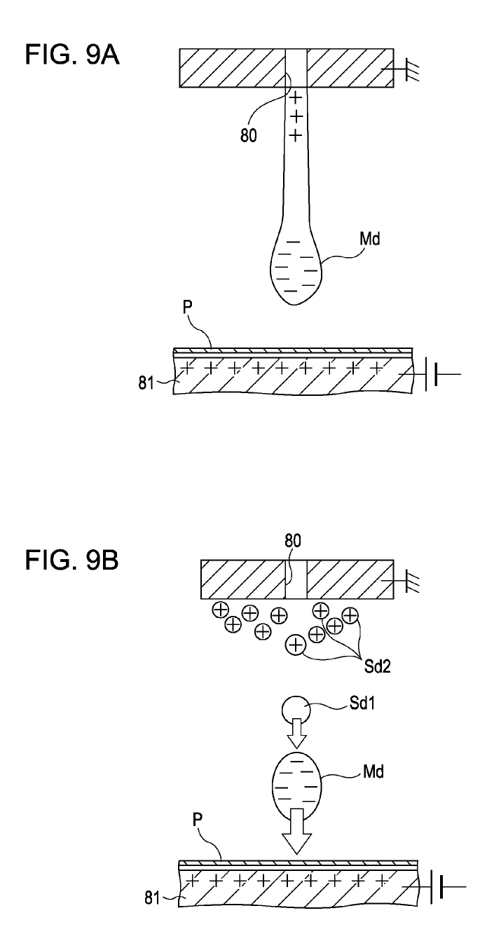

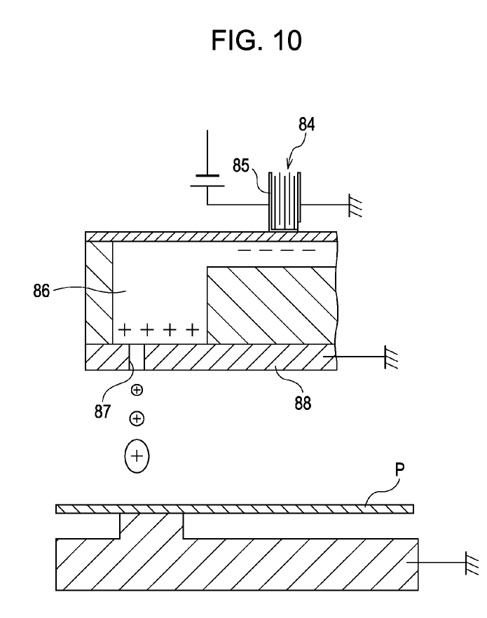

In the above-described first embodiment, the transfer belt 25 is charged by the friction between the transfer belt 25, and the transfer gear portion 20a of the reversing roller 20 and the driving gear 24, but the invention is not limited thereto. In as second embodiment, as shown in FIG. 7, the sheet feeding guide portion 9a of the sheet feeding tray 9, the body of the reversing roller 20, the auxiliary roller 28, the guide member 30, the transport driving roller 21, the platen 8, and the sheet discharge driving roller 22 are configured to be charged negatively by the friction with the recording sheet 6. That is, these members such as the sheet feeding guide portion 9a correspond to a charging member according to the invention. The members such as the sheet feeding guide portion 9a are rubbed with the recording sheet 6 being transported and is charged. Electrode plates 26′ face at least some of these members with a gap formed therebetween. Specifically, the electrode plate 26a′ is disposed at a position facing a part of the sheet feeding guide portion 9a on the rear side (the side of the sheet feeding guide portion 9a) of the sheet feeding roller 19. An electrode plate 26b′ is disposed on the opposite side to the reversing guide member 29 with the reversing roller 20 interposed therebetween and is formed in an arc shape at a position facing a part of the reversing roller 20. An electrode plate 26c′ is disposed at a position facing the auxiliary roller 28 on the upper side of the auxiliary roller 28. Electrode plates 26d′ and 26e′ are disposed at positions facing a part of the guide member 30 on the upper and lower sides of the guide member 30, respectively. Electrode plates 26f′, 26g′, and 26h′ are disposed at positions facing the transport driving roller 21, the platen 8, and the sheet discharge driving roller 22 on the lower side of the transport driving roller 21, the platen 8, and the sheet discharge driving roller 22, respectively. The electrode plates 26′ are electrically connected to the liquid droplet collection member 11 by the conductive wire 27 (in this embodiment, not shown). Since the other configuration and advantages are the same as those of the printer 1 described in the first embodiment, the description will not be made.

Next, a third embodiment will be described with reference to FIG. 8. In the third embodiment, the driving belt 16 moving the recording head 3 is configured to be charged negatively by the friction between the driving pulley 14 and the free rotation pulley 15. That is, the driving belt 16 corresponds to the charging member according to the invention. The driving belt 16 is charged by the driving of the carriage movement mechanism 7. An electrode plate 26″ has a length which is substantially the same as the length of the driving belt 16 on the upper side (the opposite side to the platen 8) and faces the portion of the driving belt 16 on the upper side with a gap formed therebetween. Further, the electrode plate 26″ is electrically connected to the liquid droplet collection member 11 by the conductive wire 27. With such a configuration, the liquid droplet collection member 11 can be charged in the movement of the recording head 3. Therefore, the mist or the like can be collected by the liquid droplet collection member 11 when the mist or the like flies due to an air current generated with the transport of the recording head 3. As a result, the mist or the like can be prevented from flying, and thus the mist or the like can be collected more reliably. Since the other configuration and advantages are the same as those of the printer 1 described in the first embodiment, the description will not be made.

The configurations of the charging member and the electrode plate are not limited to the above-described embodiments. All of the charging members and the electrode plates exemplified in the first to third embodiments may be provided or some of the charging members and the electrode plates may be arbitrarily selected and used. Further, the invention is not limited to the exemplified charging members, but a member charged by fiction with another substance may be used.

The driving signal with the positive polarity has been used in the first to third embodiments, but a driving signal with the negative polarity may be used. In this case, the ink ejected from the nozzles is charged negatively by the electrostatic induction formed by the voltage of the piezoelectric vibrator. As described, on the other hand, the flying ink is charged positively more strongly by the Lenard effect. The charging polarity of the mist or the like is determined by the electrostatic induction and the Lenard effect. However, which has a more influence on the charging polarity of the mist or the like is determined depending on various factors such as the configuration of the printer and the waveform of the driving signal, and thus it is difficult to generalize the principle. At any rate, the charging member may be formed of a material which charges the liquid droplet collection member with the opposite polarity to the polarity of the mist or the like, and thus the liquid droplet collection member may be charged with the opposite polarity to the charging polarity of the mist or the like. In this case, for example, when the electrostatic induction caused by the voltage of the piezoelectric vibrator is dominant, the mist or the like is charged negatively. Therefore, the liquid droplet collection member may be configured to be charged to the reverse polarity (positive polarity) of polarity of the driving signal (negative polarity). On the other hand, when the Lenard effect is dominant, the mist or the like is charged positively, the liquid droplet collection member may be charged to the negative polarity. In either case, the mist or the like can be collected by the liquid droplet collection member.

The invention is not limited to the printer, as long as a liquid ejecting apparatus is capable of controlling the ejection of a liquid using a pressure generation unit. The invention is applicable to various ink jet recording apparatuses such as plotters, facsimile apparatuses, copy machines or liquid ejecting apparatus, such as display manufacturing apparatuses, electrode manufacturing apparatuses, or chip manufacturing apparatuses, other than the recording apparatuses. The display manufacturing apparatus ejects solutions of color materials of R (Red), G (Green), and B (Blue) from color material ejecting heads. The electrode manufacturing apparatus ejects a liquid electrode material from an electrode material ejecting head. The chip manufacturing apparatus ejects a bioorganic solution from a bioorganic matter ejecting head.

What is claimed is:

1. A liquid ejecting apparatus comprising:
a pressure generation unit that is driven by application of a driving signal and causes a change in pressure on a liquid inside a pressure chamber;
a liquid ejecting head that ejects the liquid toward a landing target from a nozzle when the pressure generation unit is driven;
a charging member that performs charging by friction with another material;
a liquid droplet collection member that collects at least a part of a liquid droplet which has not been landed on the landing target; and
an electrode member that faces at least a part of the charging member with a gap formed between the electrode member and the charging member,
wherein the liquid droplet collection member is electrically connected to the electrode member and a charge with the same polarity as a charged polarity of the charging member is induced to the liquid droplet collection member.

2. The liquid ejecting apparatus according to claim 1, wherein the liquid droplet collection member is charged with a reverse polarity to a polarity of the driving signal.

3. The liquid ejecting apparatus according to claim 1, wherein the liquid droplet collection member is charged with a negative polarity.

4. The liquid ejecting apparatus according to claim 1, wherein the charging member is formed of a dielectric substance.

5. The liquid ejecting apparatus according to claim 1, wherein in a surface of the electrode member facing the charging member, an area of a region overlapping the charging member is greater than a contact area of the liquid droplet collection member with air.

6. The liquid ejecting apparatus according to claim 1, further comprising:
a roller that transports the landing target; and
a transfer belt that transfers a power from a power source to the roller,
wherein the transfer belt serves as the charging member.

7. The liquid ejecting apparatus according to claim 1, further comprising:
a movement mechanism that moves the liquid ejecting head,
wherein the movement mechanism includes a driving pulley installed in a driving shaft of a driving source, a free rotation pulley rotating integrally with the driving pulley, and a driving belt suspended between the driving pulley and the free rotation pulley, and
wherein the driving belt is charged by the charging member.
